(19) United States
(12) Patent Application Publication
(10) Pub. No.: US 2022/0133093 A1
(43) Pub. Date: May 5, 2022

(54) PORTABLE OUTDOOR FOOTWASHER

(71) Applicant: John MATAIRA, Pukete Hamilton (NZ)

(72) Inventors: John MATAIRA, Pukete Hamilton (NZ); Paul BROWN, Pukete Hamilton (NZ)

(73) Assignee: John MATAIRA, Pukete Hamilton (NZ)

(21) Appl. No.: 17/274,639

(22) PCT Filed: Apr. 29, 2020
(86) PCT No.: PCT/NZ2020/050038

§ 371 Date: Mar. 9, 2021

Related U.S. Application Data
(60) Provisional application No. 62/860,262, filed on Jul. 15, 2019.

(51) Int. Cl. A47K 3/022; A47K 7/02

(52) U.S. Cl. CPC A47K 3/022; A47K 7/026

(57) ABSTRACT

The present invention discloses a stationary and portable versions of a device used outdoors and indoors for general foot washing purposes of a user. The device comprises a platform affixed on or near the ground directly beneath a stationary water source. The platform has two or more brushes mounted to it to facilitate quick and efficient removal of sand, dirt and other debris from the user's foot when water flow is activated and the foot is simultaneously placed on the platform and moved back and forth in contact with the brushes, using a minimal amount of water. The device is designed to be used one foot at a time, with the user's body weight supported by the other foot. The device can also be constructed from a range of materials, including plastic, metal, wood or silicone rubber.

DETAILED DESCRIPTION OF HOW THE PRODUCT WORKS

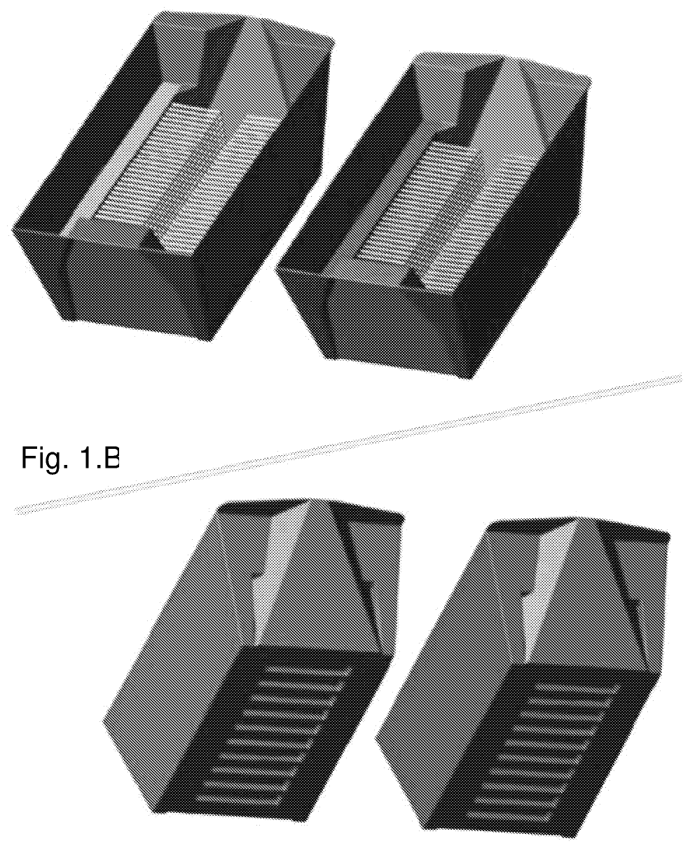

The fixed, stationary version of this device (FIG. 1) comprises a platform affixed on or near the ground directly beneath a stationary water source, to which two or more brushes are mounted, either permanently or temporarily, to facilitate the quick and efficient removal of sand, dirt and other debris from the feet when water flow is activated and the foot is simultaneously placed on the platform and moved back and forth in contact with the brushes, allowing sand and other debris to be quickly brushed off the foot and simultaneously washed down and away, using a minimal amount of water. The device is designed to be used one foot at a time, with the user's body weight supported by the other foot/leg.

The stationary version can be constructed of a range of materials such as plastic, metal, wood, or silicone rubber, and is intended to be used in permanent or semi-permanent, repeated use outdoor situations such as public beaches, beach hotels, places of worship and other establishments such as restaurants that allow members of the public and/or customers to effectively clean their feet of sand and other debris before entering vehicles or said establishments, while conserving water. The stationary version is also well suited to outdoor private home use.

The portable version of this device, (FIG. 2) which can also be used in conjunction with stationary water sources but is intended more for private than public use, particularly where no public, stationary water sources are available, incorporates the foot platform in a basin or tray big enough to accommodate feet of various sizes, inside which two or more brushes are either permanently built in or temporarily inserted, which performs the same efficient foot cleaning function as the stationary version for private/family use when the container is filled with just enough water to cover the brushes. The portable version of the device can also be constructed from a range of materials, including plastic, metal, wood or silicone rubber.

The portable, private use version of the device is intended to be carried in the user's vehicle, along with the minimum amount of water required to enable the device to work effectively if a water source is not available at the user's destination. Once the user and the rest of the occupants of the vehicle have all used the device, the device is then emptied and replaced in the vehicle. The portable version is also ideally suited to other private use situations such as foot cleaning before entering the user's house, or in other recreational and/or camping situations where feet ideally need to be cleaned before entering vehicles or buildings.

The present invention is intended primarily for outdoor use but both versions could also be used indoors for general footwashing purposes, particularly for users with age or other disability issues that are nevertheless required to wash their feet effectively and often, such as for the Islamic “wulud” mandatory ablutions ritual before prayer.

### PREFERRED ASPECTS OF THE INVENTION

Preferably, two large brushes are mounted using slots, grooves, bolts or brackets, lengthways along opposite edges of the platform in a semi-permanent fashion which nevertheless allows the brushes to be replaced once they have worn out after a reasonable period of time, or repeated heavy usage.

Preferably all or part of the foot platform is raised in some way so as to facilitate the removal of sand and debris down and away from the foot upon the application of water from above.

Preferably the foot platform is wide enough to accommodate even the largest foot between the brushes, the brushes are wide enough for the bristles to reach just above adult ankle level, and the brush bristles are long enough to almost meet in the middle so as to quickly and effectively clean both the tops and sides of the foot.

Preferably, the foot platform is also ridged, ribbed, or textured in some way so as to facilitate removal of debris from the bottom of the foot when the foot as agitated back and forth. This textured surface may also be achieved with a modified brush.

Preferably the foot platform on the stationary version would be about the length of an average adult foot in order to allow the user's foot to comfortably rest on the platform and to maximise the cleaning efficiency of the device with respect to all parts of the foot when the foot is agitated back and forth.

Preferably, in the stationary version, the platform will incorporate holes of some sort to facilitate semi-permanent or permanent installation beneath a low water source using screws or bolts. Alternatively the holes can be used to affix rubberised pad(s) feet or suction cups to the bottom of the platform for temporary or semi-permanent use, depending on what type of surface the device is placed/used upon.

Preferably the stationary version of the device should be raised or situated slightly above the ground, and be tilted slightly away from the water source and toward the user, so as to facilitate the efficient removal and rinsing of debris down and away from the foot. This raising and/or tilting can also be achieved by the the rubberised feet or suction cups in the temporary or semipermanent use situation.

Preferably the stationary version would be situated directly beneath a pulse tap/faucet to limit/conserve the amount of water used for each single use.

Preferably, the portable version of the device should be long enough to accommodate even a very large foot, and have comparatively longer brushes than the stationary device, in order to allow a reasonable amount of back and forth agitation between the brushes to quickly and efficiently clean even a very large foot.

Preferably the portable version will be deep enough to allow effective foot agitation and foot cleaning without splashing water and debris out and over the sides of the device.

Preferably the portable version will be equipped with handles at both ends and a spout at one end to facilitate easy carrying and controlled emptying of the device.

Preferably the foot platform in the portable version will be raised in the middle to create a reservoir on both sides, both to enable sand and other debris to be washed down and away from the foot, and to enable a reasonable amount of repeated (private) use before the device needs to be emptied out and refilled.

Preferably the brushes in the portable version are mounted above the platform by inserting them into angled slots at either end of the basin/tray to position the brushes at the optimal height for effective cleaning when the foot is resting on the platform.

1. Most outdoor foot cleaning devices in this field of invention, normally intended for cleaning the feet after beach or other outdoor barefoot activity before entering a vehicle or building, rely primarily on a stationary water source and consist of water showering/rinsing devices which sometimes require a large amount of water and time to effectively clean sand and other detritus from feet; or, alternatively a hand-held brush, which, even when combined with a fixed water source, is also ineffective and time consuming.

2. The present invention provides a novel solution to the problem by combining the use of brushes and water in the same device to more efficiently clean sand, dirt and other detritus from the feet, saving time and water.

3. Outdoor cleaning devices combining water and brushes do exist in the prior art, but these are specifically used for cleaning mud and dirt from work boots and shoes, typically on or near construction sites, and are fixed installations requiring a fixed water source.

4. The prior art also includes foot cleaning devices for indoor use combining water and modified brushes, but these are either expired patents or specifically designed for skin exfoliation.

5. The present invention, in both its stationary and portable versions, provides a novel solution to the problem of the outdoor washing of feet, and is more effective and versatile than other devices in this field of invention, does not rely on a fixed water source, and cuts the amount of time, and more importantly, water, used to effectively clean the feet.
